(19) United States
(12) Patent Application Publication
(10) Pub. No.: US 2026/0170403 A1
(43) Pub. Date: Jun. 18, 2026

(54) SYSTEMS AND METHODS FOR AUTOMATED SURVEYING AND ANALYSIS FOR DRILLING OPERATIONS

(71) Applicant: Apex MWD, LLC, Winnetka, IL (US)

(72) Inventors: Chad Gardner, Winnetka, IL (US); Chris Cox, Spring, TX (US); Mike Cegelski, Spring, TX (US); Billy Turner, Spring, TX (US); James ODonnell, Winnetka, IL (US)

(73) Assignee: Apex MWD, LLC, Winnetka, IL (US)

(21) Appl. No.: 18/984,546

(22) Filed: Dec. 17, 2024

(51) Int. Cl. G06N 20/00; E21B 47/024; E21B 47/07; E21B 49/00

(52) U.S. Cl. CPC G06N 20/00; E21B 47/024; E21B 47/07; E21B 49/00; E21B 2200/20

(57) ABSTRACT

A computer-implemented method of detecting events in downhole drilling data. The method includes training, by a computer, a machine learning model based on historical MWD data received from one or more MWD tools to generate a trained machine learning model. The method includes monitoring, by the computer, a stream of substantially real-time MWD data from the one or more MWD tools. The method includes detecting, by the computer, one or more events in the stream of substantially real-time MWD data using the trained machine learning model. The method includes determining, by the computer, that the detected one or more events are associated with one or more MWD data types. The method includes generating, by the computer, a notification that the one or more events have been detected.

### TECHNICAL FIELD

In some embodiments, the disclosure relates to tools used in drilling operations and, more specifically, to tools related to measurement while drilling (MWD).

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

In practice, any given drill site, such as for oil, gas, or geothermal related drilling operation, may include one or more wells for a corresponding rig, portions of which may be located deep within the well (i.e., downhole). The wells may be of varying depths, but may range up to several miles from the surface, and downhole drilling equipment may encounter extreme conditions (e.g., temperatures, pressures, torque, shock, vibration, etc.). When downhole equipment fails, the well operator may be forced to return the downhole equipment to the surface for it to be repaired or replaced, sometimes referred to as “tripping.” Such trips may result in significant non-productive time (“NPT”). Tripping for a downhole failure in a well may take 24-48 hours or more to resolve, resulting in significant NPT costs.

Measurement while drilling (MWD) may relate to the process of collecting real-time data about the wellbore while drilling operations are ongoing. In some applications, this data may help in making informed decisions to optimize the drilling process and ensure the well is drilled accurately and efficiently. MWD may be used to monitor downhole drilling conditions and may help operators identify, mitigate, or even prevent certain equipment failures. Traditional operational practices in MWD may include significant inefficiencies and operational risks stemming from the set of manual, labor intensive tasks performed, such as while taking surveys during the drilling operation for oil and gas wells (e.g., directional drilling for fracking wells). Certain operations may be subject to significant levels of human error, resulting in material costs, expenses, and fines for drillers and service companies alike. In addition, traditional MWD service providers require significant human capital in order to adequately provide their services.

Systems and methods are needed that provide increased reliability and reduced reliance on human resources in conducting MWD operations.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes a computer-implemented method of detecting significant operational events in downhole drilling data. The method may include training, by a computer, a machine learning model based on historical measurement while drilling (MWD) data received from one or more MWD tools to generate a trained machine learning model. The method may include monitoring, by the computer, a stream of substantially real-time MWD data from the one or more MWD tools. The method may include detecting, by the computer, one or more events in the stream of substantially real-time MWD data using the trained machine learning model. The method may include determining, by the computer, that the detected one or more events are associated with one or more MWD data types. The method may include generating, by the computer, a notification that the one or more events have been detected.

In another embodiment, the disclosure describes a computer-implemented method of automated drill survey generation. The method may include receiving, by a computer, a stream of substantially real-time MWD data from the one or more MWD tools. The method may include storing, by the computer, the real-time MWD data in an MWD database. Based on the MWD data in the MWD database, the method may include assessing, by the computer, one or more preconditions for generating a drilling survey. The method may include determining, by the computer, that the one or more preconditions for generating the drilling survey have been met. The method may include identifying, by the computer, a subset of the MWD data for inclusion in the drilling survey. The method may include transferring, by the computer, the subset of the MWD data to a drilling survey interface. The method may include automatically populating, by the computer, the drilling survey interface with the subset of the MWD data to generate the drilling survey.

In another embodiment, the disclosure describes a computer-implemented method of detecting events in downhole drilling data. The method may include training, by a computer, a machine learning model based on historical measurement while drilling (MWD) data received from one or more MWD tools to generate a trained machine learning model. The method may include monitoring, by the computer, a stream of substantially real-time MWD data from the one or more MWD tools. The method may include detecting, by the computer, one or more events in the stream of substantially real-time MWD data using the trained machine learning model. The method may include determining, by the computer, that the detected one or more events are associated with one or more MWD data types. The method may include generating, by the computer, a notification that the one or more events have been detected. The method may include receiving, by the computer, a user selection to either dismiss the notification or acknowledge the notification. The method may include continuously retraining the machine learning model based on the user selection.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of one or more embodiments of the present invention when read in conjunction with the accompanying drawings. The components in the figures are not necessarily to scale, emphasis instead being placed upon illustrating the principles of the invention. In the figures, like reference numerals designate corresponding parts throughout the different views, wherein:

FIG. 1 is a schematic representation of an embodiment of a drilling environment including a system for automated surveying and analysis for drilling operations in accordance with the disclosure;

FIG. 2 is a flow chart showing an embodiment of a method for automated event and failure detection in accordance with the disclosure;

FIG. 3 is a flow chart showing an embodiment of a method for automated surveys in accordance with the disclosure;

FIG. 4A is an embodiment of an example user interface for an MWD software tool in accordance with the invention;

FIG. 4B is another embodiment of the example user interface for the MWD software tool of FIG. 4A;

FIG. 5 is an embodiment of a process flow that is being automated and interface for automated surveying in accordance with the disclosure;

FIG. 6 is a schematic illustration of elements of an embodiment of an example computing device; and

FIG. 7 is a schematic illustration of elements of an embodiment of a server type computing device.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

In some embodiments, the disclosure describes systems and methods for automated surveying and analysis for drilling operations. In some embodiments, the systems and methods may use MWD techniques and data to enable partially or fully remote directional drilling operations. The systems may use robotic process automation (RPA) and artificial intelligence (AI)/machine learning (ML) algorithms to automate traditionally time consuming and costly manual processes. In some embodiments, the system (such as via AI/ML algorithms and/or systems) may identify issues in data quality in real-time or substantially real-time. In some embodiments, real-time or substantially real-time event detection algorithms may enhance screening of potential problems or issues in the downhole environment before they lead to failure or other downhole related incidents. In some embodiments, the systems and methods may provide AI/ML processes that may help ensure integrity, accuracy, and proper notification related to drilling incidents or potential equipment or other issues, as well as providing fully automated survey taking capabilities.

In some embodiments, the system may address limitations of traditional MWD systems by implementing substantially real-time AI/ML and RPA. Data quality may be an important aspect of drill site surveys. Accordingly, near real-time data feeds may be fed into the system's AI/ML algorithms to identify outliers and other issues in measurements that may adversely affect the accuracy of the survey. In some embodiments, signal processing methods may be used to suggest corrections for faulty readings, and to forecast ahead in case of sensor failure. Additionally, real-time event mining algorithms may identify more general problems and issues in a downhole environment before they lead to failure or other downhole related incidents. The combined effect of these aspects of the system may be to enable data driven monitoring by exception. Human user attention may be focused on the rare data and events that matter, providing a high degree of confidence and accuracy in all of the automated processes.

Data collected during wellbore surveying may be important for making real-time decisions about drilling direction and for subsequent well planning and development. In some embodiments implementing survey automation, RPAs may allow for seamless integration with existing MWD software systems and may be configured to interact with these systems'user interfaces to perform specific tasks. In some embodiments, such tasks may include creating surveys, reading and maintaining a survey database, updating and/or deleting surveys, conducting data consistency checks, and performing inconsistency correction. Creating surveys may include automatically initiating the survey creation process within MWD software and inputting relevant data like inclination, azimuth, and depth. The system's AI/ML models may provide a technical solution to the problem of signal noise by enhancing the signal to noise ratio in the data based on real-time drilling data and geological models. Reading and maintaining survey databases may include extracting survey data from various sources, including MWD software and rig sensors, and populating a centralized survey database. The system's AI/ML algorithms may validate data integrity, identify events, and perform quality checks. Updating and/or deleting surveys may include automatically replicating changes updates or deletions made to surveys in the MWD software, which may help ensure data consistency across systems. Data consistency checks may include periodically scraping or polling data from MWD software and comparing that data with a solutions database. The system's AI/ML algorithms may then analyze these comparisons to identify discrepancies and trigger alerts or corrective actions. Inconsistency correction may include identifying inconsistences and either executing predefined correction workflows or prompting human intervention for manual resolution. The system's AI/ML models may learn from these corrections and improve future automation accuracy. In some embodiments, the combination of RPA and AI/ML may offer a robust and efficient solution for the oil, gas, and geothermal industries by streamlining operations, reducing costs, and enhancing overall drilling performance.

Other advantages of the system may include enabling oil, gas, and geothermal drillers to more effectively monitor downhole drilling conditions and alter drilling practices that may keep the bottom hole assembly (BHA) drilling. When downhole equipment fails, the operator may be forced to return some or all of the downhole equipment back to the surface in order for it to be replaced, referred to as “tripping” within the industry. These trips may result in significant amounts of non-productive time or “NPT”. Tripping for a downhole failure in the production section of some of these wells can take 24-48 hours or more, resulting in very high NPT costs for the operator. The system may significantly assist operators with minimizing this NPT by detecting events, outliers, and other inconsistencies in the data, enabling real-time correction or, if necessary, escalation to a human operator for further review and intervention. This may ensure the integrity and accuracy of the drilling data, which may lead to improved decision-making and optimized drilling operations.

In some embodiments, the system's combination of RPA and AI/ML may create a closed-loop system that may continuously learn and adapt to the drilling environment, further enhancing the system's performance and reliability over time. This represents a significant advancement in the field of MWD/LWD, offering the potential for fully autonomous and remote drilling operations with unprecedented levels of efficiency, accuracy, and safety.

In some embodiments, the system may allow directional drilling operators to fully or substantially fully automate the drilling process while simultaneously reducing errors, costly downtime, and safety related concerns associated with having personnel present at the drilling location. The system collects large, proprietary datasets on drilling operations across multiple formations and rigs. The system may, in come embodiments, analyze, detect, and predict equipment performance, equipment failure modes, and required maintenance based on geological formation, temperature, and other measures of down hole conditions. In some embodiments, the system may include a physical platform that may allow for the complete or nearly complete automation of remote directional drilling capabilities.

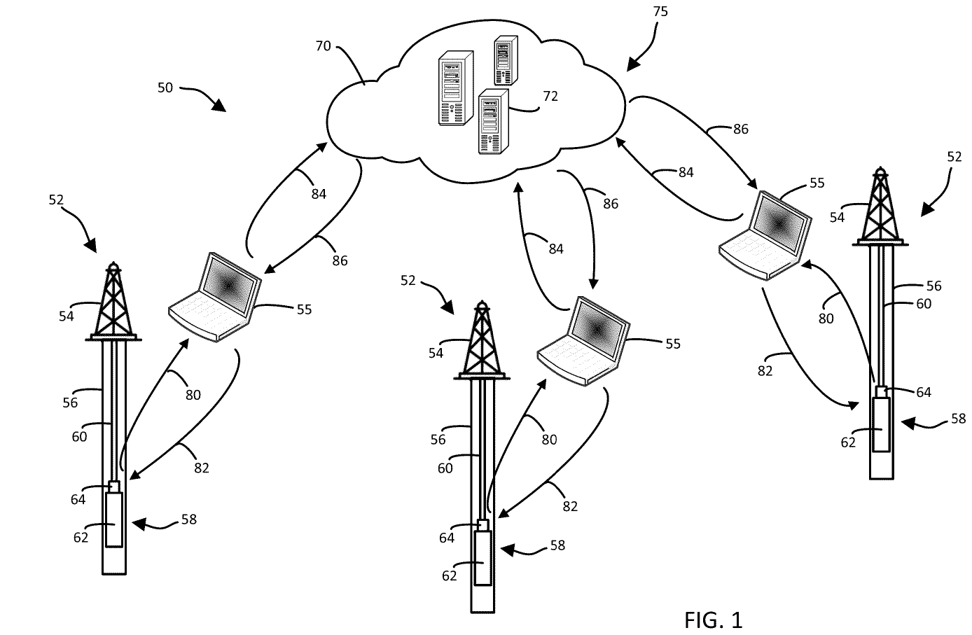

FIG. 1 shows an embodiment of an example drilling environment 50 in which the systems and methods for automated surveying and analysis for drilling operations may exist and operate. The environment 50 may include one or more well sites 52, which each include a drilling rig 54 and a well 56. Each drilling rig 54 may include a bottom hole assembly (“BHA”) 58 disposed in the well 56 (i.e., “downhole”), which may be connected to the surface via a drill string 60. In some embodiments, the BHA 58 may include a drill bit 62, which may dig the well, a motor to drive the drill bit, and a downhole MWD tool 64 that may be disposed at or near the drill bit. In some embodiments there are also other components included in the drill string, such as an agitator or rotary steerable tool (“RSS”) or other such components as may be deemed necessary in any particular drilling application. In some embodiments, the downhole MWD tool 64 may include various downhole sensors and signal generation and transmission equipment. The downhole sensors may include magnetometers, gyroscopes, accelerometers, thermocouples, inertial measurement unit (IMU), etc., that may acquire downhole data such as pressure, temperature, wellbore inclination, azimuth, torque, shock, vibration, etc. In some embodiments, the downhole sensors may also sense natural gamma rays, resistivity, and other properties of the surrounding rock formations, which may help in identifying the types of formations being drilled through.

The signal generation and transmission equipment may generate signals based on the data collected by downhole sensors and transmit them to the surface, as indicated by downhole data transmissions 80. In some embodiments, the transmission methods may include mud pulse, electromagnetic, acoustic signaling, or any other suitable transmission method. Surface receiving equipment may receive the signals generated and transmitted by the downhole signal generation and transmission equipment, decode those signals into comprehensible data describing downhole conditions, and transmit the decoded data to one or more computer workstations 55. The workstations 55 may include one or more computers to receive, process, and display the downhole data.

In some embodiments, the downhole data may be used to steer the drill string 60 and make informed decisions about the borehole path. In some embodiments, the workstations 55 and/or the surface receiving equipment may include instrumentation for transmitting signals 82 to the downhole assembly 58, such as instructions for steering, changing direction, speed, angle, etc., of drilling. In some embodiments, the workstations 55 and/or surface receiving equipment may transmit data or instructions to the downhole assembly 58, such as changing or affecting transmission speeds, data sequences, survey sequences, etc. The data may also be used to reduce drilling hazards, improve drilling productivity, and ensure drilling in authorized areas. The downhole data may also allow for monitoring the operation of the drill bit and drill string, including parameters such as speed and smoothness of bit rotation, downhole vibration and temperature, torque and pressure on the drill bit, flow rate of drilling fluid, etc., which may help maximize the usable life and performance of the drilling equipment.

In some embodiments, the workstations 55 may be part of a local area network (LAN) or wide area network (WAN) or any other suitable digital communications network 75 (e.g., the internet) that may include workstations 55 associated with other well sites 52, other computing devices, and/or a cloud computing environment 70 that may include one or more server-type computers, such as analysis servers 72. The workstations 55 may be connected to the LAN or WAN or other computing components in any suitable manner familiar to those skilled in the art.

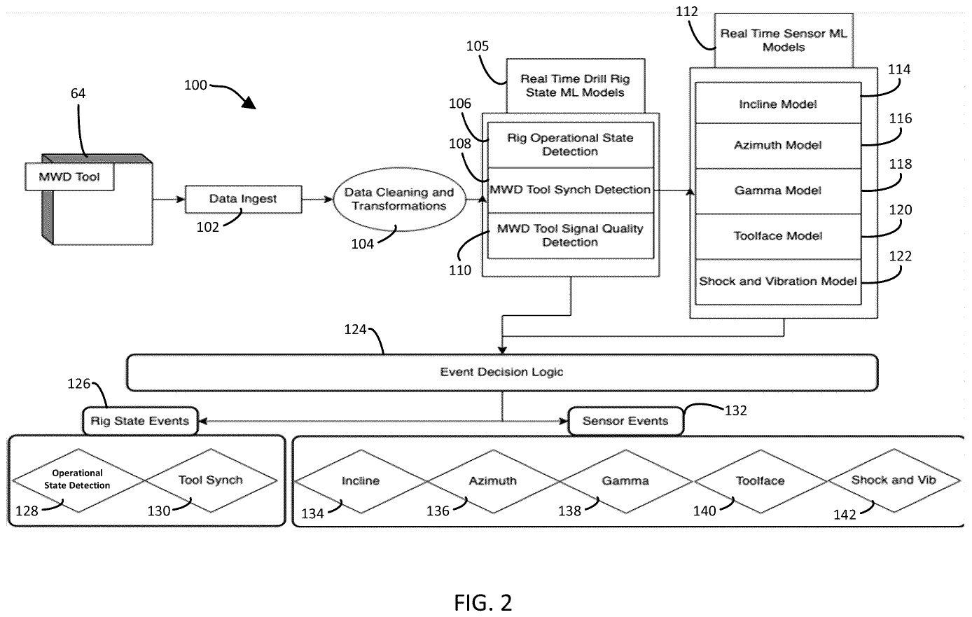

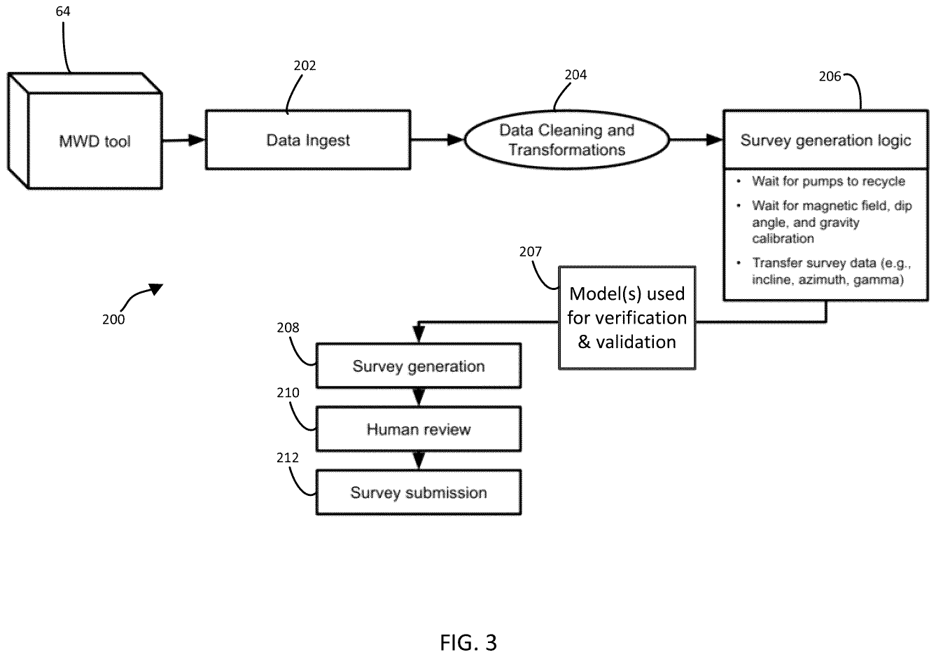

In some embodiments, the downhole data received from the MWD tool 64 via downhole data transmissions 80 may be received, processed, and/or transmitted to one or more analysis servers 72 via a digital communications network 75. In some embodiments, the one or more analysis servers 72 may perform all or portions of the methods described in more detail below with respect to FIGS. 2 and 3. In some embodiments, one or more of the steps in those methods may be performed partially on the workstations 55 or other computers located at one or more of the well sites 52. In some embodiments, the one or more analysis servers 72 may be a single server, or may be any number of networked servers in communication with one another at a single geographic location or at various geographic locations. In some embodiments, the one or more analysis servers 72 may transmit analysis data 86 to the workstations 55 or other suitable computing system for review, analysis, display, or other purposes described herein.

In some embodiments, the analysis server 72 may be configured to perform an automated event and failure detection process and/or an automated survey process using information provided from the MWD tool 64 and other inputs as described in more detail below. The analysis server 72 may include or may be a part of an artificial neural network (ANN) and/or recurrent neural network (RNN) that may perform machine learning and/or artificial intelligence operations as described below.

### Automated Event Monitoring and Failure Detection System

FIG. 2 includes a flow chart showing an embodiment of a method 100 for automated event and failure detection. In some embodiments, the primary inputs for the method may be substantially continuous streams of data from downhole sensors such as the MWD tool 64 (e.g., measuring parameters such as pressure, temperature, vibration, operational state, signal quality, tool synch, etc.), other drilling rig sensors (e.g., weight on bit, rotary speed, flow rate), and measurement while drilling and/or logging while drilling (MWD/LWD) tools (e.g., inclination, azimuth, gamma ray). In some embodiments, historical data such as past drilling data, geological models, and performance records may be used to train one or more AI/ML models and improve their predictive capabilities. In some embodiments, additional inputs may be provided, such as drilling plans, target objectives, or specific instructions for the system. One or more of these inputs may be received at the analysis server 72 from the MWD tool 64, the workstations 55, or other origination points and ingested at a data ingest 102 step. In some embodiments, data ingest may include gathering data from various sources such as databases, sensors, or user inputs, including the MWD tool 64, workstations 55, user inputs, historical databases, etc.

At 104, the analysis server 72 may perform a data cleaning and transformations step. In some embodiments, data cleaning and transformation may include removing noise, handling missing values, normalizing the data to ensure consistency, etc. In some embodiments, the analysis server 72 may also perform feature extraction to identify relevant feature from the data (e.g., sensor data such as azimuth, incline, vibration, angle, etc.). In some embodiments, the data may be transformed from an original format to a transformed format that may be read by the appropriate models or that may otherwise be usable to perform the appropriate analysis. In some embodiments, the analysis server 72 may convert or otherwise prepare the data into a state that may be readable and usable by one or more real time drill rig state and/or real time sensor machine learning (ML) models.

In some embodiments, the one or more real time drill rig state machine learning (ML) models 105 may be machine learning or deep learning models, such as artificial neural networks (ANNs), recurrent neural networks (RNNs), autoencoders, supervised learning models (e.g., regression, classification, etc.), unsupervised learning models (e.g., clustering, dimensionality reduction, etc.), semi-supervised learning, self-supervised learning, reinforcement learning, etc. The one or more real time drill rig state ML models may operate based on various types of downhole and other data received related to the state of the BHA 58, environmental factors (e.g., temperature, pressure, etc.), or attributes of the drilling rig at the time MWD measurements are being made. For example, the real time drill rig state ML models may include rig operational state detections at 106, MWD tool synch detection at 108, and MWD tool signal quality detection at 110. In some embodiments, the one or more real time drill rig state ML models 105 may have been trained using historical data pertaining to drill rig states and/or drill rig states in the broader context of other historical data (e.g., sensor data). The real time drill rig state ML models 105 may be trained in a variety of ways to identify events in the drill rig operational data being received at the analysis server 72. For example, some training methods may include statistical methods to determine data points that may deviate significantly from a mean or median, machine learning algorithms such as clustering (e.g., K-means) or classification (e.g., isolation forest, once-class support vector machine (SVM) to distinguish normal data from events, and/or deep learning models (e.g., autoencoders and recurrent neural networks (RNNs) for more complex event detection). In some embodiments, the real time drill rig state ML models 105 may be constantly or periodically updated as more data is received and processed.

In some embodiments, rig operational state detection 106 may be a model configured to detect events in the operational state of the rig, such as components of the BHA 58, the drill string 60, and other rig components based on historical training. In some embodiments, the operational state of the rig at a given point in time may include, for example, drilling, tripping in hole, tripping out of hole, etc. In some embodiments, the rig operational state detection model 106 may detect events in the incoming data stream received at the analysis server 72 related to rig operational state. In some embodiments, the model 106 may monitor incoming sensor data and may identify readings or circumstances that may significantly deviate from the expected values and that may indicate a current or future problem with the drilling rig's operational state.

MWD tool synch detection 108 may include detecting events related to a synch detection of the MWD tool, such as MWD tool 64. In some embodiments, synch detection may relate to identifying the start of a data transmission sequence between the MWD tool 64 and the workstations 55, for example, that may help ensure that data packets sent from the downhole MWD tool 64 to the workstations 55 may be correctly aligned and interpreted. In some embodiments, the MWD tool synch detection model 108 may detect events in the incoming data stream received at the analysis server 72 related to MWD tool synch detection. In some embodiments, the model 108 may monitor incoming sensor data and may identify readings or circumstances that may significantly deviate from the expected values and that may indicate a current or future problem with the synch detection or data transmission between the MWD tool 64 and the workstations 55. In some embodiments, the MWD tool synch detection data 108 may be transmitted to or otherwise ingested by the real time sensor ML models to identify which sets of real-time sensor data and other relevant rig data from the MWD tool 64 correspond to a given timeframe or data packet.

MWD tool signal quality detection 110 may include monitoring and/or determining a signal quality between the MWD tool 64 and the surface at any given time for a given packet of sensor data, such as a connection between the MWD tool and the workstations 55. In some embodiments, the MWD tool signal quality detection may provide an indicator of a confidence level in the downhole data arriving at the surface at a given time. For any given set of downhole data (e.g., data packet), the model 110 may use the tool signal quality as a factor to determine whether the corresponding downhole data should be included in any given analysis, or how much weight should be given to that set of data. For example, data arriving from the MWD tool at a time corresponding to relatively poor signal quality may be given less weight by the analysis server 72 and its models than data arriving from the MWD tool at a time corresponding to relatively higher signal quality. In some embodiments, MWD tool signal quality detection 110 may detect events in the incoming data stream received at the analysis server 72 related to tool signal quality. In some embodiments, signal quality detection may be used to help ensure accurate data from downhole instruments (e.g., the MWD tool 64) to the workstations 55. In some embodiments, the model 110 may monitor incoming sensor data and may identify readings or circumstances that may significantly deviate from the expected values and that may indicate a current or future problem with the MWD tool signal quality that may call into question the reliability of the corresponding downhole data. In some embodiments, additional real time drill states may also be incorporated into the real time drill rig state ML models at 105.

At 112, in some embodiments, the one or more real time sensor machine learning (ML) models at 112 may be an integrated system including a stack of machine learning models, automated hypotheses generation, and causal inference. In some embodiments, the one or more real time sensor ML models 112 may be machine learning or deep learning models, such as artificial neural networks (ANNs), recurrent neural networks (RNNs), autoencoders, supervised learning models (e.g., regression, classification, etc.), unsupervised learning models (e.g., clustering, dimensionality reduction, etc.), semi-supervised learning, self-supervised learning, reinforcement learning, etc. In some embodiments,, via the analysis server 72, the one or more real time sensor ML models may analyze the incoming data stream of cleaned and/or transformed downhole data. The one or more real time sensor ML models 112 may include at least an incline model 114, and azimuth model 116, a gamma model 118, a toolface model 120, and a shock and vibration model 122. In some embodiments, each real time sensor model 112, both alone and/or in combination with one another and/or with the real time drill rig state ML models 105, may incorporate one or more machine learning techniques to identify events with a particular type of downhole data received from the workstation 55 and the MWD tool. For example, a particular data packet received from the workstation 55 may include time-based state data for the rig and its environment (e.g., rig operational state, MWD tool synch, MWD tool signal quality, etc.) and data from the downhole sensors (e.g., incline, azimuth, gamma, toolface, shock and vibration, etc.). Based on historical training data, each real-time sensor model 112 may develop base expectations for each individual data type in view of the other data corresponding to a given time and/or in view of historical data trends identified in the data stream coming from the MWD tool. In other words, the real-time sensor models 112 may identify that a particular data type (e.g., azimuth data) may be outside an expected range based on historical data for that data type. Additionally, the real-time sensor models 112 may identify that a particular data type may be outside an expected range based on current and/or historical data for that data type in view of other data types (e.g., incline data, temperature data, etc.). The models 112 may identify data that, while not itself outside expectations given the current data context, may represent a data trend in view of recent data for that or other data types. In some embodiments, the real-time sensor models 112 may each identify that a particular data type in view of expectations gleaned from a combination of all the historic and/or current data, which may be constantly updated based on new data and/or user feedback to identified events.

Each model may be based at least in part on training data for that type of data and other data that may correspond to that particular data type. In some embodiments, the one or more real time sensor ML models 112 may have been trained using historical data pertaining to real-time downhole sensors and/or the broader context of other historical data (e.g., drill rig state data, etc.). The real time sensor ML models 112 may be trained in a variety of ways to identify events in the sensor data being received at the analysis server 72. For example, some training methods may include statistical methods to determine data points that may deviate significantly from a mean or median, machine learning algorithms such as clustering (e.g., K-means) or classification (e.g., isolation forest, once-class support vector machine (SVM) to distinguish normal data from events, and/or deep learning models (e.g., autoencoders and recurrent neural networks (RNNs) for more complex event detection). In some embodiments, the real time sensor ML models 112 may be constantly or periodically updated as more data is received and processed.

In some embodiments, the incline model 114 may be a model configured to detect events in the incline data based on the model's training. Incline data may be MWD tool data relating to the measurement of the wellbore's inclination, i.e., the angle between a vertical axis and the wellbore. In some embodiments, incline data may be used in directional drilling to help ensure the wellbore follows a planned trajectory. In some embodiments, incline data may be sensed using accelerometers to detect gravitational force along different axes and transmitted to the workstations 55. In some embodiments, the incline model 114 may detect events in the incoming data stream received at the analysis server 72 related to the incline data based on the incline data itself and/or the broader context of the real-time sensor data, historical training data, and real-time drill rig state ML models. The model 114 may monitor incoming sensor data and may identify readings or circumstances that may significantly deviate from the expected values and that may indicate a current or future problem with the incline itself and/or the incline data.

In some embodiments, the azimuth model 116 may be a model configured to detect events in the azimuth data based on the model's training. Azimuth data may be MWD tool data relating to a horizontal direction of the wellbore relative to a reference direction, e.g., true north or magnetic north. Azimuth data may be used in directional drilling operations to help ensure the wellbore follows a planned trajectory. In some embodiments, azimuth data may be sensed using magnetometers and/or gyroscopes. Magnetometers may detect the direction of the magnetic field, which may allow for the calculation of the wellbore's orientation relative to magnetic north. In some embodiments, gyroscopes may be used to determine wellbore orientation, particularly in scenarios with significant magnetic interference. Both magnetometers and gyroscopes may transmit readings to the workstations 55 for decoding and transmission on to the analysis server 72. In some embodiments, the azimuth model 116 may detect events in the incoming data stream received at the analysis server 72 related to the azimuth data. The model 116 may monitor incoming sensor data and may identify readings or circumstances that may significantly deviate from the expected values and that may indicate a current or future problem with the azimuth.

In some embodiments, the gamma model 118 may be a model configured to detect events in gamma data based on the model's training. Gamma data may be MWD tool data relating to the measurement of naturally occurring gamma radiation in rock formations. In some embodiments, gamma data may help in identifying different rock types and their properties. In some embodiments, gamma data may help in navigating the drill bit to stay within a desired geological formation. Gamma ray sensors on the BHA 58 may detect gamma rays and transmit associated data to the workstations 55, which may be transmitted on to the analysis server 72. In some embodiments, the gamma model 118 may detect events in the incoming data stream received at the analysis server 72 related to the gamma data. The model 118 may monitor incoming sensor data and may identify readings or circumstances that may significantly deviate from the expected values and that may indicate a current or future problem with the incline.

In some embodiments, the toolface model 120 may be a model configured to detect events in toolface data based on the model's training. Toolface data may be MWD tool data relating to the orientation of the drill bit's face relative to a reference direction, which may help in controlling the direction of the wellbore. In some embodiments, toolface orientation may be based on magnetic toolface data measured using magnetometers and/or gravity toolface data measured using accelerometers. In some embodiments, magnetic toolface data may be used when the wellbore inclination may be relatively small, such as less than 5-8 degrees. In some embodiments, gravity toolface may be used when the wellbore inclination may be relatively large, such as greater than 5-8 degrees. Magnetometers or accelerometers may transmit the associated data to the workstations 55, which may be transmitted on to the analysis server 72. In some embodiments, the toolface model 120 may detect events in the incoming data stream received at the analysis server 72 related to the toolface data. The model 120 may monitor incoming sensor data and may identify readings or circumstances that may significantly deviate from the expected values and that may indicate a current or future problem with the toolface orientation.

In some embodiments, the shock and vibration model 122 may be a model configured to detect events in shock and vibration data based on the model's training. Shock and vibration data may be MWD tool data relating to forces acting upon the drill bit, such as acceleration and vibration, which may help in reducing or preventing damage to the drill bit and other downhole components. Monitoring these forces may help in taking preventative measures to protect the downhole equipment. Additionally, excessive vibrations may reduce drilling efficiency by causing the drill bit to bounce or stick-slip, which may result in slower drilling rates and/or increased wear on the drill bit. In some embodiments, shock and/or vibrational forces may be measured using accelerometers or other impact sensors, which may detect both lateral and axial vibrations. In some embodiments, the MWD tool 64 may transmit the associated vibrational data to the workstations 55, which may be transmitted on to the analysis server 72. In some embodiments, the shock and vibration model 122 may detect events in the incoming data stream received at the analysis server 72 related to the shock and vibration data. The model 122 may monitor incoming sensor data and may identify readings or circumstances that may significantly deviate from the expected values and that may indicate a current or future problem with the drill bit or other components. If a problem is identified, drilling parameters may be adjusted in real-tie to account or the problem and maintain optimal drilling conditions.

At 124, the analysis server 72 may implement event decision logic to determine whether or not any events detected by the real-time drill rig state ML models 105 and/or the real-time sensor ML models 112 may be present, and/or whether those events justify triggering an anomaly alert. In some embodiments, the event decision logic at 124 may be an event decision model that may take into account the results of analyses performed at steps 105-122. In some embodiments, based on historical training data and model analysis, the analysis server 72, using the event decision logic 124, may determine whether anything in the most recent data stream and corresponding model analysis is outside of expectations and thus should trigger an anomaly alert.

In some embodiments, the event decision logic 124 may not be based on one data type of the various data types analyzed, but may be based on a set of parameters that, in view of the model's training data and current data context, correlates with scenarios that have been identified as problems in the past based on the training dataset. For example, even if one or more real-time sensor ML models 112 may indicate that particular data point for one or more particular data types may be outside of an expected value, the event decision logic 124 may still determine that, based on the training date, the current parameters may not rise to the level of triggering an alert. Alternatively, the analysis server 72 may determine that, for a given set of parameters, over a given time period, the triggering of an alert may be warranted. In some embodiments, the parameters in which triggering an alert may be warranted by the event decision logic 124 may be constantly changing based on ongoing machine learning based on near constantly updating data sets.

If the analysis server 72 determines that no anomaly alert should be triggered, the system 100 adds the latest data stream to the historical data and proceeds with data ingest of the next data packet at 102. If, using the event decisions logic 124, the analysis server 72 determines that an anomaly alert should be triggered based on one or more of the real-time drill rig state ML models 105, the analysis server 72 may trigger a rig state event alert at 126. If, using the event decisions logic 124, the analysis server 72 determines that an anomaly alert should be triggered based on one or more of the real-time sensor ML models 112, the analysis server 72 may trigger a sensor event alert at 132. The rig state events 126 may include events related to, for example, operational state detection 128, tool synch 130, and/or other parameters related to drill rig state as described herein. In some embodiments, the sensor events 132 may include events related to, for example, incline 134, azimuth 136, gamma 138, toolface 140, shock and vibration 142, and/or other parameters related to the MWD tool and associated downhole sensors.

In some embodiments, when the analysis server 72 determines that an alert should be triggered based on the event decision logic 124, the analysis server may transmit an alert notification to the one or more workstations 55. In some embodiments, the workstations 55 may be running software that may include an MWD user interface and/or survey software. The MWD user interface may include visual notifications, such as pop-up windows, color changes, flashing colors/lights, etc., to indicate to a user that the analysis server 72 has triggered an alert. In some embodiments, the notifications may include an audible component, such as a sound or spoken words identifying the alert or aspects of the alert. In some embodiments, the notifications may indicate information about the triggered alert, such as the particular drill site, a reason the alert was triggered, a time associated with the alert, etc. In some embodiments, the user interface may present the user with an option to accept or dismiss the alert. This may be presented via visual buttons to select or other suitable mechanisms for user input. In some embodiments, the user interface may provide an option to review the alert in more detail, such as by selecting a “Review” button. Upon selection of the Review button, the user interface may provide additional information as to why the alert has been triggered, which may include presenting one or more current or historical data points that the analysis server 72 may have determined resulted in the alert being triggered. If the user agrees that the alert may be legitimate and that action may need to be taken as a result, the user may initiate such action. In some embodiments, the user interface may additionally provide information regarding what potential actions may be taken to address the situation leading to the alert. In any event, the response of the user to the triggered alert may be logged and fed back into the analysis server 72 and its various models for additional machine learning training data for subsequent data inputs.

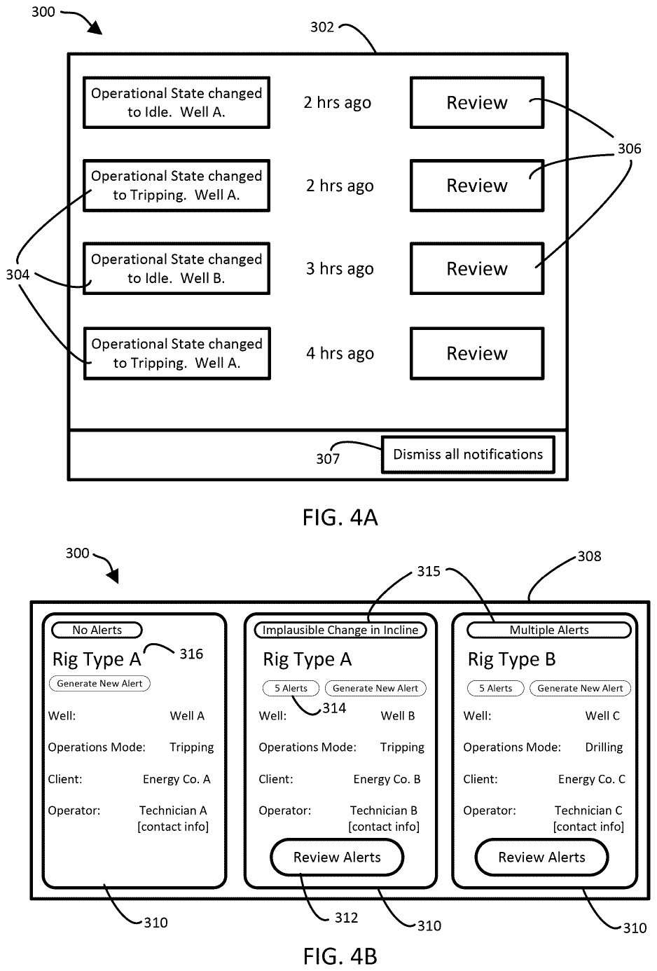

FIG. 4A shows an embodiment of a notification window 302 that may be implemented in an embodiment of an MWD user interface 300. The notification window 302 may include a listing of one or more notifications 304 for alerts triggered by the analysis server 72. In this embodiment, the user interface 300 may include a Review button 306 that may be selected by the user to show additional information related to the particular notification 304, and may provide the user with an option to dismiss or accept the particular notification. In some embodiments, the notification window 302 may include an option to “dismiss all notifications” which the user may select to dismiss all pending notifications in the notification window. FIG. 4B shows an embodiment of a drill site notification window 308 that may include one or more drill site info screens 310. In some embodiments, each drill site info screen 310 may include information about each particular drill site, such as well name, operations mode (e.g., tripping, drilling, etc.), the owner of the well (i.e., client), the operator, etc. In some embodiments, the drill site info screen 310 may include a drill type 316 and an alert status 315. The alert status 315 may indicate whether the particular drill and/or well has any alerts, or what type of alert or alerts may be active. In some embodiments, the drill site info screen 310 may include an alert quantity indicator 314 that may show a number of alerts that may have been triggered for that particular well in a given amount of time, or since a user has dismissed or otherwise cleared the alert notifications. In some embodiments, selecting the alert quantity indicator 314 and/or the alert status 315 may cause the notification window 302 to be displayed showing notifications/alerts for the particular well. In some embodiments, the drill site notification window 308 may include indication on the individual drill site info screens 310 that may be related to the number of alerts and/or the urgency of those alerts. For example, the color of each individual drill site info screen may change as urgency thresholds may be reached, such as numbers of alerts and/or urgency of alerts. In some embodiments, the drill site info screens 310 may be black if no alerts are pending, and may turn to yellow if a first threshold number of alerts (e.g., 1-3 alerts) are pending, and may turn to orange if a second threshold number of alerts (e.g., 4-6 alerts) are pending, and may turn red if a third threshold number of alerts (e.g., 7 or more alerts) are pending. Of course, those skilled in the art will recognize that other method of alerts or urgency rating may be used consistent with the scope of the disclosure.

In some embodiments, the analysis server 72 may generate and/or transmit notifications in other ways than via the using interface 300. For example, the analysis server 72 may transmit all notifications or particularly notifications via email, text message, instant message, etc. In some embodiments, the user interface 300 may include settings to select particular types of notifications to be transmitted to certain phone numbers, email addresses, instant messages, etc., in certain scenarios. For example, a user may select certain types of alerts to be sent to user A and user B, and other types of alerts (e.g., more urgent or rare alerts) to user C using one or more transmission methods. In some embodiments, a user may select that a notification may be transmitted to one or more users or correspondence addresses when an alert threshold for certain types of alerts or clusters of alerts within a predetermined time period occur. For example, a user may select that a particular user be sent a notification via text message if three of a particular type of alert having a particular urgency are triggered within a one hour period. Those skilled in the art will recognize that users may select virtually any combination of alerts, clusters, time periods, and/or urgency levels the meet an alert threshold for a particular user or contact address (e.g., telephone number, email address, etc.).

In some embodiments, the MWD user interface, which may run on the one or more workstations 55 or may exist on the analysis server 72 and be accessed remotely using the workstations, may provide selection options for users to calibrate parameters in which the real-time drill rig state ML models, the real-time sensor ML models, and/or the event decision logic 124 may operate. For example, the user interface may include options (such as via data fields, sliders, buttons, pull-down menus, etc.) for users to indicate a sensitivity level of each model or of the system more generally. In such embodiments, a user may adjust, either quantitatively or qualitatively or both, an alert threshold for what particular types of MWD data or levels of unexpected data may rise to the level of generating an alert. For example, the user interface may include an alert sensitivity slider that, when moved, may increase or decrease the event decision logic's sensitivity to triggering alerts when unexpected data may be encountered by the models 105, 112. In some embodiments, the sensitivity slider may have units of numbers of alerts, types of alerts, or time periods. In some embodiments, the sensitivity slider may have no units at all, but may indicate a relatively general level of model sensitivity compared to other slider positions. For example, when the sensitivity may be set at a relatively high level (e.g., via the slider or other input method), the event decision logic 124 may trigger an alert even when relatively few unexpected data points may be identified in the models, or relatively low variance in the expected to unexpected data. On the other hand, when the sensitivity may be set at a relatively low level, the even decision logic 124 may only trigger alerts when relatively many or large variances of data values may be encountered. In some embodiments, the user interface may include separate sensitivity selection options for each or some of the individual model 105-122 so that the user may calibrate the model sensitivity in more fine-grained ways.

In some embodiments, using the analysis server 72, the one or more workstations 55, and/or a combination of both along with other drill control component, the automated anomaly and failure detection system may use one or more AI/ML drill correction models to determine corrective measures to be taken in response to alerts triggered by the event decision logic or other models. The drill correction models may be trained on historical data including the MWD data from the downhole sensors, the alerts triggered by the real-time drill rig state ML models and/or the real-time sensor ML models, and any corrective measures taken by the users or drill operators to address the alerts. For example, the drill correction model may be trained on data that includes alerts that were triggered based on particular circumstances, what was done to react to those alerts, and whether the corrective measures were affective at addressing the underlying circumstances that triggered the one or more alerts. Based on this training data, the drill correction model may suggest a course of corrective action in view of an alert, or may, in some embodiments, automatically control the drill rig itself to address the alerts. In some embodiments, the drill correction model may be configured to automatically take corrective action in response to certain types of alerts or circumstances, but may not take automatic action in others. For example, in some embodiments, the drill correction model may be configured to instruct the workstation 55 or other drill rig control components to correct relatively minor problems, either qualitatively minor or with variance from expected data that may be relatively small. But the same drill correction model may be configured to request human intervention for relatively large problems. Those skilled in the art will appreciate that different combinations of alert types, time periods, etc., may be used to configure the drill correction model to take automatic action, wait for human intervention, and/or suggest corrective action.

In some embodiments, the MWD software may include a user interface that may provide inputs for a user to set thresholds for when the MWD software and/or drill correction model may take automatic corrective action to address one or more alerts, or when it should not. For example, the user may select alerts related to particular data types for the drill correction model to address automatically (e.g., rising temperature, pressure, vibration, etc.), and may select alerts to particular data types for the drill correction model to leave for human intervention (e.g., azimuth, incline, etc.). In some embodiments, the types of alerts may be scored using a rating system (e.g., alert score), and the user may set an alert score threshold. In some embodiments, when the alert score may be below the alert score, the drill correction model and corresponding computer and control components may be configured to automatically take corrective action to address the alerts. However, if the alert score threshold may be surpassed, the drill control model may be configured to request human intervention to address the alerts. Of course, those skilled in the art will appreciate that a threshold for automatic drill correction may be determined in other suitable ways within the scope of the disclosure.

In each embodiment, the automated anomaly and failure detection system provides a technological solution to various technical problems. For example, the system may provide a technological solution to the technical problem of automatically identifying potential problems with downhole mining data that may lead to equipment damage, dangerous drilling conditions, inefficient drilling, etc. The system may also provide a technological solution to the technical problem of processing large amounts of data to identify relationships in the data that may not be evident or possible for a human. Accordingly, the automated anomaly and failure detection system may represent a technological improvement in at least the fields of mining, data collection and processing, machine learning, and artificial intelligence.

### Automated Survey System

FIG. 3 includes a flow chart showing an embodiment of a method 200 for automatically generating drilling surveys related to mining operations. In some embodiments, the analysis server 72 may implement AI/ML survey models to make decisions on when to create surveys, what parameters to include, and how to update or delete them based on real-time data and pre-defined rules. In some embodiments, the primary inputs for the method 200 may be similar to those used in method 100, that is, substantially continuous streams of data from downhole sensors such as the MWD tool 64 (e.g., measuring parameters such as pressure, temperature, vibration, operational state, signal quality, tool synch, etc.), other drilling rig sensors (e.g., weight on bit, rotary speed, flow rate), and measurement while drilling and/or logging while drilling (MWD/LWD) tools (e.g., inclination, azimuth, gamma ray). In some embodiments, additional inputs may be provided, such as drilling plans, target objectives, or specific instructions for the system. One or more of these inputs may be received at the analysis server 72 from the MWD tool 64, the workstations 55, or other origination points and ingested at a data ingest 202 step. In some embodiments, data ingest 202 may include gathering data from various sources such as databases, sensors, or user inputs, including the MWD tool 64, workstations 55, user inputs, historical databases, etc.

At 204, the analysis server 72 may perform a data cleaning and transformations step. In some embodiments, data cleaning and transformation may include decoding data signals, removing noise, handling missing values, normalizing the data to ensure consistency, etc. In some embodiments, the analysis server 72 may also perform feature extraction to identify relevant features from the data (e.g., sensor data such as azimuth, incline, vibration, angle, etc.). In some embodiments, the data may be transformed from an original format to a transformed format that may be read by the appropriate models or that may otherwise be usable for generating surveys. In some embodiments, the analysis server 72 may convert or otherwise prepare the data into a state that may be readable and usable by survey software. In some embodiments, AI/ML algorithms may be utilized to identify events, outliers, and inconsistencies, which may help ensure data integrity and reliability. In some embodiments, the analysis server 72 may store the cleaned and transformed data in an MWD database

At 206, the method 200 may include implementing survey generation logic. In some embodiments, survey generation logic may include rules for identifying the appropriate timing and/or preconditions for creating a new survey, harvesting the appropriate data in the MWD database for inclusion in the survey, and transmitting that data to the appropriate input locations in the survey software. In some embodiments, the survey generation logic 206 may include monitoring drilling data, such as drill position and progress, to determine when to generate a new survey. For example, the survey generation logic 206 may include a rule for generating a new survey whenever the drill bit drills a predetermined survey distance (e.g., 90 feet). When the analysis server 72 determines that the drilling rig has drilled the predetermined distance based on the downhole data received at data ingest 202, the survey generation logic may include 206 determining whether other survey conditions may have been satisfied prior to survey generation. For example, the survey generation logic 206 may include checking whether drilling fluid pumps have been recycled. In some embodiments, recycling pumps may refer to the process of recirculating drilling fluid through the system and the fluid that may be used for pressure transmissions of downhole data (e.g., mud pulse telemetry). Other conditions may be related to the magnetic field level, the dip angle, gravity calibration, etc. The survey generation logic may include determining whether those conditions may be within a predetermined tolerance range. In some embodiments, if those conditions are not within the predetermined tolerance range, the pumps may be recycled before survey data may be taken, such as by transmitting the appropriate survey data from the database (e.g., incline, azimuth, gamma, etc.).

Once the analysis server 72 has determined that the predetermined conditions and/or tolerance ranges are satisfied based on the downhole data and other parameters, the method 200 may include, at 207, using one or more ML/AI models to verify and/or validate the survey data. In some embodiments, the ML/AI model used may include one or more of the real time drill rig state ML models 105 or the real time sensor ML models 112 described with references to FIG. 2. In some embodiments, the ML/AI model may be a separately trained model trained based on training data from a database of historical surveys. If the ML/AI model determines that the survey data may not be within expected parameters, the analysis server 72 may cancel the survey, and/or may generate a notification or other alert to indicate that unexpected survey data may have been encountered. If the ML/AI model determines that the survey data may indeed be within expected values or parameters given the temporal and instant context of the drilling operation, the analysis server 72 may, at 208, generate a new survey at 208 that may be populated with the appropriate survey data. In some embodiments, the analysis server 72 may automatically select the appropriate data and may transfer the survey data from the MWD database into the survey software. In some embodiments, the analysis server 72 may transform the survey data transferred from the MWD database based on an application programming interface (API) for a particular type of survey software. For example, a first API for a first type of survey software may take the survey data in a first form, while a second API for a second type of survey software may take the survey data in a second form. The analysis server 72 may identify the type of survey software and corresponding API, and may transform the data accordingly before transmitting it to the survey software to generate a new survey.

In some embodiments, at 210, the analysis server 72 may wait for and/or request review by a human user, such as via a notification in a user interface. The user interface may include an input option for the user to accept the survey and, at 212, submit the automatically generated server to a predetermined location (e.g., send via email to a proper authority, store in a survey database, transmit to other interested parties, etc.). In some embodiments, the method 200 may include submitting a generated survey without any human review, or may include requesting human review only periodically (e.g., 1 of every 5 or 10 surveys). In some embodiments, the method 200 may include requesting human review for particular predetermined types of surveys and not for other types. For example, in some embodiments, the method 200 may include only requesting human review if the analysis server 72 recognizes irregularities or values for the survey data outside of expected values based on the AI/ML models and historic training data. For example, the analysis server 72 may determine that human review may be requested if the generated survey includes azimuth values outside of an expected range in view of historical data and/or other MWD data values.

In each embodiment, the automated survey system and methods described herein may provide a technical solution to the technical problem of automatically determining and/or identifying when to generate a survey, identifying the appropriate survey data in the MWD database for inclusion in the survey, and transforming the MWD data into a form that a particular type of survey software may utilize to generate and/or submit each survey. Traditionally, generating surveys has been relatively labor intensive, requiring users to perform fairly repetitive tasks by identifying the particular timing for a survey, which data to include, and what steps to perform for a particular type of survey software. In other words, the technical problem of determining the timing of a survey and the appropriate data to include has been addressed by human users in a labor-intensive way. The automated survey system and methods instead provides a technical solution to this technical problem by providing an automated system for generating surveys, selecting and transforming the appropriate data, and transmitting that data into the survey in a particular way. Accordingly, the automated survey system and methods represent a technical improvement in at least the field of mining, data collection and manipulation, machine learning, and artificial intelligence.

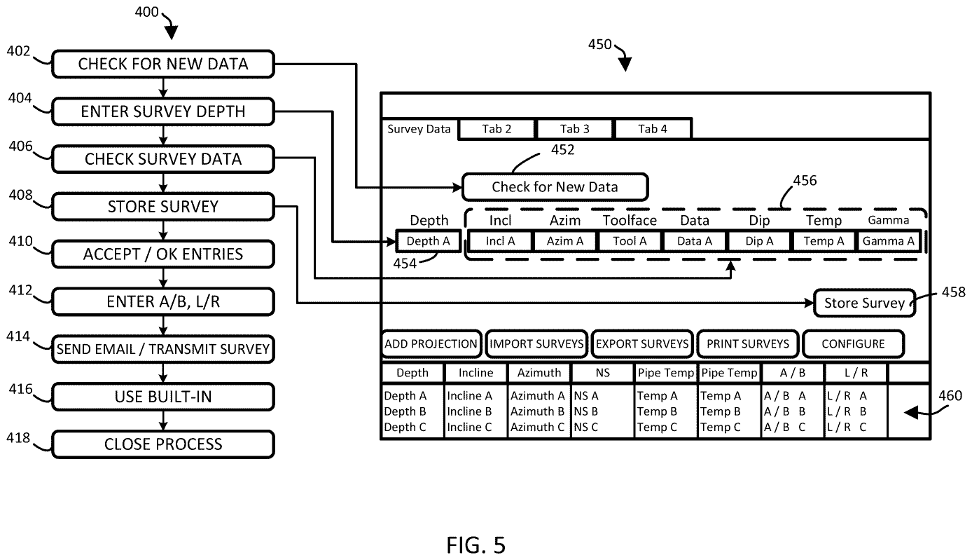

FIG. 5 shows an example embodiment of an interface 450 for generating a survey with a particular type of survey software, along with a process flow 400 for the analysis server 72 to automatically generate a survey. At 402, the method may include clicking on or otherwise selecting an option to check for new data, such as new MWD data in the MWD database received from the MWD tool. In some embodiments, the interface 450 may include a button for the analysis server 72 to automatically select, such as a new data button 452. At 404, the automatic survey generation process may include the analysis server 72 automatically entering a survey depth, such as by automatically populating a Depth field 454. In some embodiments, the analysis server 72 may determine the survey depth by identifying the appropriate MWD data in the MWD database pertaining to the drill depth, or by entering the depth value for which a survey may be desired. At 406, the process 400 may include checking the survey data that may have been automatically populated based on the depth value entered in the Depth field. For example, the analysis server 72 may automatically identify the appropriate survey data in the MWD database (e.g., MWD database 460) that may correspond to the particular depth entered in the Depth field 454 and may automatically fill in the appropriate fields for the particular data type (e.g., incline, azimuth, gamma, temperature, etc.). The appropriate survey data may be automatically transmitted from the MWD database, transformed to be accepted by the particular type of survey software, and entered into the appropriate MWD data fields 456. Checking survey data may include, in some embodiments, requesting review from a human user, or automatically double checking that the appropriate survey data has been entered into the appropriate MWD data fields 456. At 408, the process 400 may include automatically making a selection to store the newly generated survey, such as by clicking or otherwise selecting an option to store the survey. The example interface 450 may include a store survey button 458 that may be automatically selected by the analysis server to store the generated survey in an appropriate predetermined location, such as within a log in the survey software itself or in a survey database.

In some embodiments, the process 400 may include additional steps that may be particular to a type of survey software or may be more generally applicable. For example, the process 400 may include selecting an OK button at 410, entering appropriate values (e.g., A/B, L/R values) at 412, and automatically causing the survey software to send the survey such as via email at 414. In some embodiments, additional steps may be performed, such as automatically selecting a use built-in option at 416, and selecting close to end the survey generation process at 418. Those skilled in the art will recognize that variations on the process 400 and the interface 450 may be present in particular embodiments without straying from the scope of the disclosure.

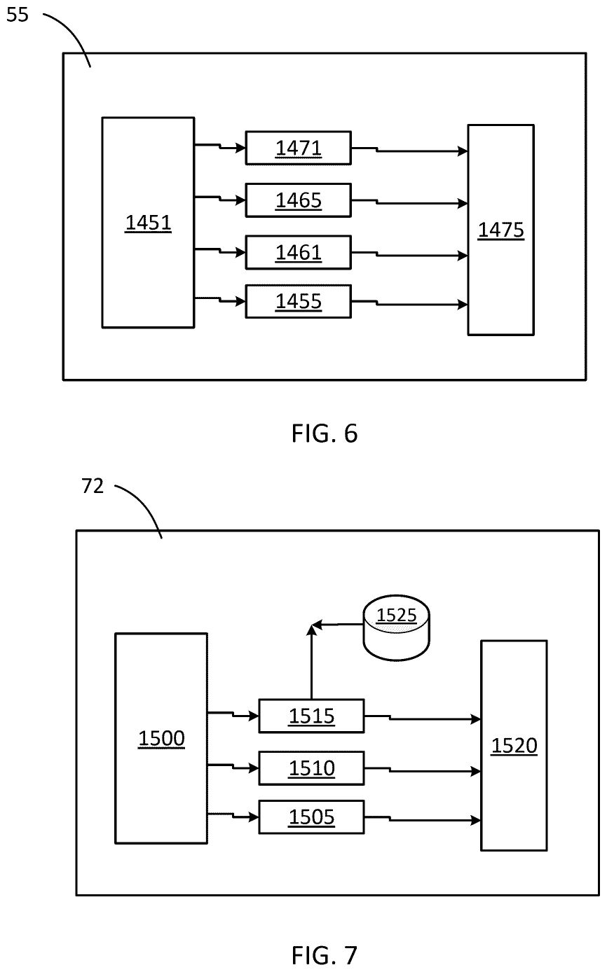

FIG. 6 is a simplified illustration of some physical elements that may make up an embodiment of a computing device, such as the computer workstation 55, and FIG. 7 is a simplified illustration of the physical elements that make up an embodiment of a server type computing device, such as may be used for the one more remote analysis servers 72. Referring to FIG. 6, a sample computing device 55 is illustrated that is physically configured to be part of the systems and method for dynamic neural network conditioning. The computing device 55 may have a processor 1451 that is physically configured according to computer executable instructions. In some embodiments, the processor may be specially designed or configured to optimize communication between a server relating to the system described herein. The computing device 55 may have a portable power supply 1455 such as a battery, which may be rechargeable. It may also have a sound and video module 1461 which assists in displaying video and sound and may turn off when not in use to conserve power and battery life. The computing device 55 may also have volatile memory 1465 and non-volatile memory 1471. The computing device 55 may have GPS capabilities that may be a separate circuit or may be part of the processor 1451. There also may be an input/output bus 1475 that shuttles data to and from the various user input/output devices such as a microphone, a camera, a display, or other input/output devices. The computing device 55 also may control communicating with networks either through wireless or wired devices. Of course, this is just one embodiment of a computing device 55 and the number and types of computing devices 55 is limited only by the imagination.

The physical elements that make up an embodiment of a server, remote analysis server 72, are further illustrated in FIG. 7. In some embodiments, the server 72 may be specially configured to run the system and methods for dynamic neural network conditioning as disclosed herein. At a high level, the server 72 may include a digital storage such as a magnetic disk, an optical disk, flash storage, non-volatile storage, etc. Structured data may be stored in the digital storage database. More specifically, the server 72 may have a processor 1500 that is physically configured according to computer executable instructions. In some embodiments, the processor 1500 can be specially designed or configured to optimize communication between a computing device, such as computer workstation 55, and A/V equipment or remote cloud server 72 as described herein. The server 72 may also have a sound and video module 1505 which assists in displaying video and sound and may turn off when not in use to conserve power and battery life. The server 72 may also have volatile memory 1510 and non-volatile memory 1515.

A database 1525 for digitally storing structured data may be stored in the memory 1510 or 1515 or may be separate. The database 1525 may also be part of a cloud of servers and may be stored in a distributed manner across a plurality of servers. There also may be an input/output bus 1520 that shuttles data to and from the various user input devices such as a microphone, a camera, a display monitor or screen, etc. The input/output bus 1520 also may control communicating with networks either through wireless or wired devices. In some embodiments, a MWD analysis controller and/or MWD automatic survey control for running an MWD analysis API and/or an MWD automatic survey API may be located on the computing device 55. However, in other embodiments, such controllers may be located on server 72, or both the computing device 55 and the server 72. Of course, this is just one embodiment of the server 72 and additional types of servers are contemplated herein.

The figures depict preferred embodiments for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer-implemented method of detecting drilling events in downhole drilling data, the method comprising:
training, by a computer, a machine learning model based on historical measurement while drilling (MWD) data received from one or more MWD tools to generate a trained machine learning model;
monitoring, by the computer, a stream of substantially real-time MWD data from the one or more MWD tools;
detecting, by the computer, one or more events in the stream of substantially real-time MWD data using the trained machine learning model;
determining, by the computer, that the detected one or more events are associated with one or more MWD data types; and
generating, by the computer, a notification that the one or more events have been detected and require action.

2. The method of claim 1, wherein the MWD data includes at least one of azimuth data, incline data, temperature data, gamma data, toolface data, torque data, pressure data, or shock and vibration data.

3. The method of claim 1, wherein the MWD data includes at least one of rig operational state data, MWD tool synch data, or MWD tool signal quality data.

4. The method of claim 1 further comprising cleaning and transforming the MWD data.

5. The method of claim 1 further comprising:
training, by the computer, an incline data machine learning model based on the historical MWD data; and
detecting, by the computer, one or more events related to incline data included in the stream of substantially real-time MWD data.

6. The method of claim 1 further comprising:
training, by the computer, an azimuth data machine learning model based on the historical MWD data; and
detecting, by the computer, one or more events related to azimuth data included in the stream of substantially real-time MWD data.

7. The method of claim 1 further comprising:
training, by the computer, a gamma data machine learning model based on the historical MWD data; and
detecting, by the computer, one or more events related to gamma data included in the stream of substantially real-time MWD data.

8. The method of claim 1 further comprising:
training, by the computer, a toolface data machine learning model based on the historical MWD data; and
detecting, by the computer, one or more events related to toolface data included in the stream of substantially real-time MWD data.

9. The method of claim 1 further comprising:
training, by the computer, shock and vibration data machine learning model based on the historical MWD data; and
detecting, by the computer, one or more events related to shock and vibration data included in the stream of substantially real-time MWD data.

10. A computer-implemented method of automated drill survey generation, the method comprising:
receiving, by a computer, a stream of substantially real-time MWD data from the one or more MWD tools;
storing, by the computer, the real-time MWD data in an MWD database;
based on the MWD data in the MWD database, assessing, by the computer, one or more preconditions for generating a drilling survey;
determining, by the computer, that the one or more preconditions for generating the drilling survey have been met;
identifying, by the computer, a subset of the MWD data for inclusion in the drilling survey;
transferring, by the computer, the subset of the MWD data to a drilling survey interface; and
automatically populating, by the computer, the drilling survey interface with the subset of the MWD data to generate the drilling survey.

11. The method of claim 10, wherein the one or more preconditions include a predetermined wellbore depth, a predetermined magnetic field, a predetermined dip angle, or a gravity calibration.

12. The method of claim 10, wherein the one or more preconditions include a drilled distance from a previous survey.

13. The method of claim 10 further comprising transmitting, by the computer, the drilling survey to a predetermined recipient.

14. The method of claim 10 further comprising storing the drilling survey in a survey database.

15. The method of claim 10 further comprising transforming the subset of MWD data into a data format readable by the drilling survey interface.

16. The method of claim 10, wherein the subset of MWD data corresponds to a drill depth.

17. The method of claim 10, wherein the subset of MWD data includes one or more of azimuth data, incline data, gamma data, temperature data, or pressure data.

18. A computer-implemented method of detecting critical events in downhole drilling data, the method comprising:
training, by a computer, a machine learning model based on historical measurement while drilling (MWD) data received from one or more MWD tools to generate a trained machine learning model;
monitoring, by the computer, a stream of substantially real-time MWD data from the one or more MWD tools;
detecting, by the computer, one or more critical events in the stream of substantially real-time MWD data using the trained machine learning model;
determining, by the computer, that the detected one or more critical events are associated with one or more MWD data types;
generating, by the computer, a notification that the one or more critical events have been detected;
receiving, by the computer, a user selection to either dismiss the notification or acknowledge the notification; and
continuously optimizing the machine learning model based on user feedback and event labeling related to the one or more critical events.

19. The method of claim 18, wherein the MWD data includes at least one of azimuth data, incline data, temperature data, gamma data, toolface data, torque data, pressure data, or shock and vibration data.

20. The method of claim 18, wherein the MWD data includes at least one of rig operational state data, MWD tool synch data, or MWD tool signal quality data.
